(19) United States
(12) Patent Application Publication
(10) Pub. No.: US 2025/0200427 A1
(43) Pub. Date: Jun. 19, 2025

(54) OPTIMIZING EMBEDDING USING DIMENSION ATTENTION FOR CONTRASTIVE LEARNING

(71) Applicant: Optum, Inc., Minnetonka, MN (US)

(72) Inventors: Brian Lawrence HILL, Culver City, CA (US); Eran HALPERIN, Santa Monica, CA (US); Gregory D. LYNG, Minneapolis, MN (US); Kimmo M. KARKKAINEN, Santa Monica, CA (US)

(21) Appl. No.: 18/541,777

(22) Filed: Dec. 15, 2023

(51) Int. Cl. G06N 20/00

(52) U.S. Cl. CPC G06N 20/00

(57) ABSTRACT

Embodiments provide processing of time-series data for improved embedding and processing, specifically using dimension attention for contrastive learning. The improved embedding enables the creation of more accurate embeddings within an embedding space, including an embedding space shared between the data types, via contrastive learning and dimension attention.

### TECHNICAL FIELD

Embodiments of the present disclosure generally relate to improved embedding of data, and specifically to generation of improved models using contrastive learning and attention mechanisms.

### BACKGROUND

Various embodiments of the present disclosure address technical challenges related to accurately embedding data in an embedding space and provide solutions to address the efficiency and reliability shortcomings of existing embedding mechanisms.

### BRIEF SUMMARY

In general, various embodiments of the present disclosure provide methods, apparatuses, systems, computing devices, computing entities, and/or the like for performing improved embedding optimization using dimension attention for contrastive learning.

In one aspect, a computer-implemented method includes generating, by one or more processors, a second embedding of a portion of signal data in an embedding space using a second model, wherein the embedding space is shared with a first embedding generated based on a portion of first data and a first model in the embedding space, wherein the portion of first data comprises a first data type and the portion of signal data comprises a second data type, wherein the second model is trained at least in part using contrastive learning of the first data type and the second data type, and wherein the second model identifies one or more attention masks for one or more dimensions of the second embedding and generates the second embedding based on the one or more attention masks; and initiating, by the one or more processors, a process based on the second embedding.

The computer-implemented method may also further include training, by the one or more processors, the second model to generate the second embedding of the signal data in the embedding space; and generating, by the one or more processors, the one or more attention masks for the one or more dimensions of the second embedding during training of the second model.

The computer-implemented method may also include where the portion of first data comprises international classification of disease code data associated with one or more identifiers.

The computer-implemented method may also include where the first model includes a neural network.

The computer-implemented method may also further include training, by the one or more processors, the first model to generate the first embedding of the portion of first data in the embedding space.

The computer-implemented method may also include the portion of first data comprises a data record embodying a combination of data portions associated with a shared identifier.

The computer-implemented method may also include where the set of signal data includes monitoring data collected by a wearable device worn by a patient.

The computer-implemented method may also include where the portion of signal data comprises a combined signal comprising a plurality of channels that each correspond to a different data type of a plurality of different data types.

The computer-implemented method may also include where generating the second embedding includes inputting, by the one or more processors, the portion of signal data in parallel to each of a convolutional neural network and a convolutional attention network, wherein the convolutional attention network generates the one or more attention masks for the one or more dimensions of the second embedding, and wherein the second embedding is based on a combination of the one or more attention masks and a feature map generated by the convolutional neural network.

The computer-implemented method may also further include pre-training, by the one or more processors, the second model using the contrastive learning based on: (i) a set of positive queries based on a first set of signal data corresponding to a shared identifier, or (ii) a set of negative queries associated with a first identifier based on a second set of signal data corresponding to a second identifier.

The computer-implemented method may also include where the second embedding corresponds to a first identifier, and where the contrastive learning of the second embedding and the first embedding includes applying, by the one or more processors, a loss function that (i) decreases as the second embedding is closer to the first embedding in a circumstance where the first embedding is associated with a shared identifier matching the first identifier, and (ii) increases as the second embedding is closer to the first embedding in a circumstance where the first embedding is associated with a second identifier that differs from the first identifier.

The computer-implemented method may also include where initiating the process based on the second embedding includes determining, by the one or more processors, a nearest embedding corresponding to the first data type in the embedding space for the second embedding by at least applying the second embedding to a nearest neighbor algorithm associated with identifying at least one other embedding of the first data type.

The computer-implemented method may also include where initiating the process based on the second embedding includes determining, by the one or more processors, a nearest embedding corresponding to the second data type in the embedding space for the second embedding by applying the second embedding to a nearest neighbor algorithm associated with identifying one or more other embedding of the second data type.

The computer-implemented method may also include where the monitoring data includes data signals from a continuous glucose monitor.

The computer-implemented method may also include where the convolutional neural network includes any number of convolutional layers, each convolutional layer includes the same input signal length and output signal length.

The computer-implemented method may also include where the convolutional attention network comprises any number of convolutional layers that generates a plurality of filters processed via a sigmoid activation function, and wherein the convolutional attention network individually processes each sub-portion of the portion of signal data corresponding to a different timestep.

The computer-implemented method may also further include normalizing, by the one or more processors, results data generated by the sigmoid activation function for each timestep to sum to one.

The computer-implemented method may also further includes generating, by the one or more processors, modified signal data comprising performing an element-wise multiplication of the one or more attention masks with the feature map.

In accordance with another aspect of the disclosure, a system is provided that includes one or more processor and one or more memory having computer program code stored thereon that, in execution with the one or more processor, configures the system to perform any one of the example methods described herein.

In accordance with another aspect of the disclosure, a computer program product is provided that includes one or more non-transitory computer-readable storage medium having computer program code stored thereon that, in execution with at least one processor, configures the computer program product to perform any one of the example methods described herein.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example computing system in accordance with at least one embodiment of the present disclosure.

FIG. 2 illustrates a schematic diagram showing a system computing architecture in accordance with at least one embodiment of the present disclosure.

FIG. 3 illustrates a visualization of a data architecture for storing embeddings of a plurality of data types to an embedding space in accordance with at least one embodiment of the present disclosure.

FIG. 4 illustrates a visualization of an embedding space maintaining a plurality of embeddings of different data types in accordance with at least one embodiment of the present disclosure.

FIG. 5 illustrates visualization of a data architecture of a specially configured model during training of the model in accordance with at least one embodiment of the present disclosure.

FIG. 6 illustrates a visualization of a data architecture for initiating a first downstream process based on the improved trained models in accordance with at least one embodiment of the present disclosure.

FIG. 7 illustrates a visualization of a data architecture for initiating a second downstream process based on the improved trained models in accordance with at least one embodiment of the present disclosure.

FIG. 8 illustrates a flowchart depicting example operations of a process in accordance with at least one embodiment of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout. Moreover, while certain embodiments of the present disclosure are described with reference to predictive data analysis, one of ordinary skill in the art will recognize that the disclosed concepts may be used to perform other types of data analysis.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specially-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

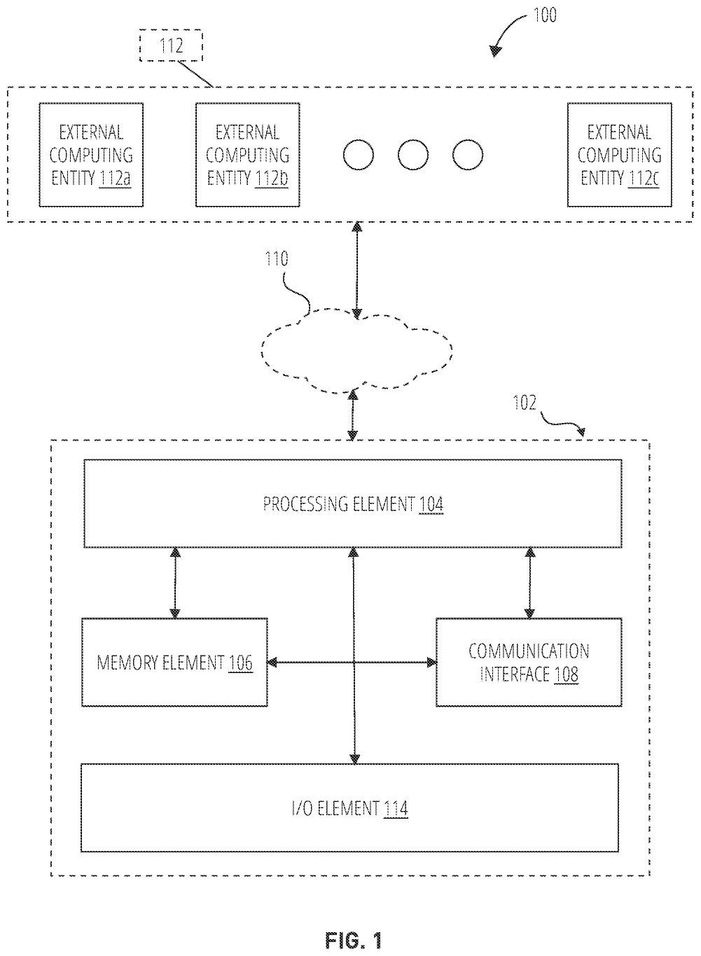

FIG. 1 illustrates an example computing system 100 in accordance with one or more embodiments of the present disclosure. The computing system 100 may include an embedding computing entity 102 and/or one or more external computing entities 112a-c communicatively coupled to the embedding computing entity 102 using one or more wired and/or wireless communication techniques. The embedding computing entity 102 may be specially configured to perform one or more steps/operations of one or more evaluation techniques described herein. In some embodiments, the embedding computing entity 102 may include and/or be in association with one or more mobile device(s), desktop computer(s), laptop(s), server(s), cloud computing platform(s), and/or the like. In some example embodiments, the embedding computing entity 102 may be configured to receive and/or transmit one or more data objects from and/or to the external computing entities 112a-c to perform one or more steps/operations of one or more evaluation techniques described herein. Non-limiting examples of the evaluation techniques include the learns, using dimension attention-based contrastive learning, to generate embeddings for any number of data types associated with collected data portions as depicted and described further herein. Additionally or alternatively, in some embodiments, the techniques described herein improve efficiency and accuracy of the models that generate such embeddings, thus reducing the error associated with such models compared to the amount of training data entries needed to train such models, as well as the accuracy of downstream processes performed based on such embeddings. Additionally or alternatively, the techniques described herein improve the computational efficiency, storage-wise efficiency, and/or speed of configuring accurate machine learning models.

The external computing entity 112a-c, for example, may include and/or be associated with one or more data centers and/or production environments. The data centers, for example, may be associated with one or more data repositories storing data that may, in some circumstances, be processed by the embedding computing entity 102 to provide dashboard(s), machine learning analytic(s), evaluation process(es), and/or the like. Additionally or alternatively, in some embodiments the external computing entity 112a-c represent production environments. By way of example, the external computing entities 112a-c may be associated with a plurality of entities. A first example external computing entity 112a, for example, may host a registry for the entities. By way of example, in some example embodiments, the entities may include one or more service providers and the external computing entity 112a may host a registry (e.g., the national provider identifier registry, and/or the like) including one or more clinical profiles for the service providers. Additionally or alternatively, in some embodiments, the external computing entity 112a may include service provider data indicative of medical encounters serviced by the service provider, for example including patient data, CPT and/or diagnosis data, and/or the like. In addition, or alternatively, a second example external computing entity 112b may include one or more claim processing entities that may receive, store, and/or have access to a historical interaction data set for the entities. In this regard, the external computing entity 112b may include such patient data, CPT and/or diagnosis data, claims data, other code data, and/or the like for any of a number of medical encounters. In some embodiments, the external computing entity 112b embodies one or more computing system(s) that support particular operations of an insurance or other healthcare-related entity that generate and/or otherwise utilize a particular set of data and/or sets of data. In some embodiments, a third example external computing entity 112c may include a data processing entity that may preprocess particular data, for example international classification of disease (ICD) data, signal data, and/or other set of data, to generate one or more data objects descriptive of one or more aspects of the historical interaction data set. Additionally or alternatively, in some embodiments, the external computing entities includes an external computing entity embodying a central data warehouse associated with one or more other external computing entities, for example where the central data warehouse aggregates data across a myriad of other data sources. Additionally or alternatively, in some embodiments, the external computing entities includes an external computing entity embodying a user device or system that collect(s) user health and/or biometric data, for example embodying signal data. For example, in some embodiments one or more of the external computing entities 112a, 112b, and/or 112c embodies a wearable device or other user device that collects a set of data for further processing. Additionally or alternatively still, in some embodiments, one or more of the external computing entities 112a-112c embody a monitoring environment in which particular signal data and/or other user-related data is collected and/or stored.

The embedding computing entity 102 may include, or be in communication with, one or more processing element 104 (also referred to as processors, processing circuitry, digital circuitry, and/or similar terms used herein interchangeably) that communicate with other elements within the embedding computing entity 102 via a bus, for example. As will be understood, the embedding computing entity 102 may be embodied in a number of different ways. The embedding computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the embedding computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the embedding computing entity 102 with the assistance of the processing element 104. Additionally or alternatively, in some embodiments the memory element 106 supports a database of a set of data for further processing via a specially configured ML model as depicted and described herein.

As indicated, in one embodiment, the embedding computing entity 102 may also include one or more communication interface 108 for communicating with various computing entities such as the embedding computing entity 1022a-c, such as by communicating data, content, information, and/or similar terms used herein interchangeably that may be transmitted, received, operated on, processed, displayed, stored, and/or the like.

In some embodiments, any of the external computing entity 112a-112c may communicate with the embedding computing entity 102 through one or more communication channels using one or more communication networks, for example the communications network 110. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

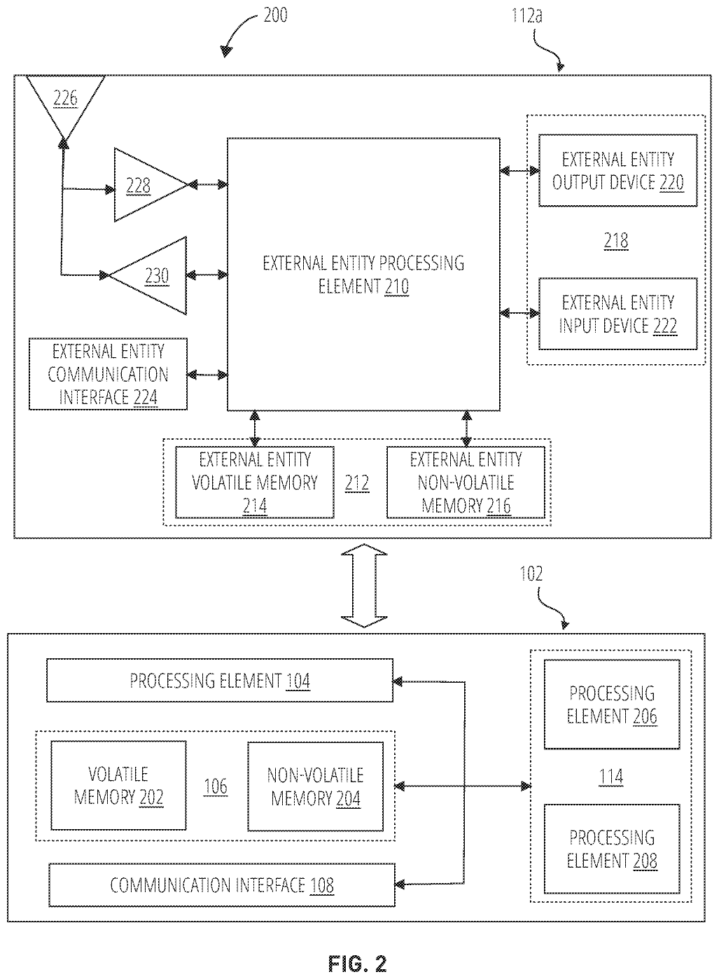

FIG. 2 is a schematic diagram showing a system computing architecture 200 in accordance with some embodiments discussed herein. In some embodiments, the system computing architecture 200 may include the embedding computing entity 102 and/or the external computing entity 112a of the computing system 100. The embedding computing entity 102 and/or the external computing entity 112a may include a computing apparatus, a computing device, and/or any form of computing entity configured to execute instructions stored on a computer-readable storage medium to perform certain steps or operations.

The embedding computing entity 102 may include a processing element 104, a memory element 106, a communication interface 108, and/or one or more I/O elements 114 that communicate within the embedding computing entity 102 via internal communication circuitry such as a communication bus, and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the embedding computing entity 102 to perform one or more step/operations described herein.

Implementations of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established, or fixed) or dynamic (e.g., created, or modified at the time of execution).

The embedding computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The embedding computing entity 102 may include one or more I/O elements 114. The I/O elements 114 may include one or more output devices embodied at least in part by processing element 206 and/or one or more input devices embodied at least in part by processing element 208 for providing and/or receiving information with a user, respectively. The output devices may include one or more sensory output devices such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices may include one or more sensory input devices such as one or more tactile input devices (e.g., touch sensitive displays, push buttons, and/or the like), one or more audio input devices (e.g., microphones, and/or the like), and/or the like.

In addition, or alternatively, the embedding computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the embedding computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry such as a communication bus, and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the embedding computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O elements 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Example of Certain Terms

“Attention mask” refers to electronically managed data that emphasizes one or more portions of timeseries data.

“Channel” with respect to a data object refers to a particular vector, array, or other data structure storing a defined number of data values for a particular data object. In some contexts, each channel corresponds to a length of time in a timeseries. The data object may include any number of channels corresponding to any number of sets of data of different data types.

“Combined signal” refers to electronically managed data generated from a plurality of other data portions. Non-limiting examples of a combined signal in some embodiments includes (i) data having a plurality of channels where each channel includes data from a different data portion, (ii) data having at least one channel that includes data values generated from a mathematical combination of data values from a plurality of data portions.

“Contrastive learning” refers to a machine learning technique in which embeddings of data are learned such that data instances deemed similar to one another are represented by embeddings proximate to one another in the embedding space and data instances deemed dissimilar to one another are represented further from one another in the embedding space.

“Convolutional attention network” refers to a specially configured neural network that generates an attention mask using at least one convolutional layer and at least one attention mechanism.

“Data type” refers to a classification of data object. In some embodiments, a data type refers to a configuration of data properties embodying a particular classification of data object.

“Dimension” refers to a particular field of a vector representing a feature derived from data or a combination of features derived from the data.

“Dimension attention” refers to mechanisms that generates an attention mask for a particular dimension of a data portion.

“Element-wise multiplication” refers to matrix-based multiplication of matrices of corresponding elements in at least two matrices.

“Embedding” refers to electronically managed data embodying a representation of data values via derived data values for one or more features of an embedding space.

“Embedding space” refers to a multi-dimensional space that represents higher-dimensional data with one or more features.

“Identifier” refers to electronically managed data representing a particular entity associated with data.

“Model” refers to an algorithmic, statistical, and/or machine learning model specially configured to learn output data from particular input data based on data patterns, insights, and/or other learnings from training data.

“Modified signal data” refers to particular signal data updated based on at least one attention mask.

“Monitoring data” refers to signal data that is collected by at least one wearable device.

“Nearest embedding” with respect to a particular embedding in a particular embedding space refers to data embodying an embedding in the particular embedding space that is determined to be next most similar to the particular embedding based on a minimum distance between the particular embedding space and the at least one other embedding.

“Nearest neighbor algorithm” refers to any process that determines a second embedding in an embedding space associated with the least distance to a first embedding in the embedding space.

“Negative query” refers to a determination of one or more sample embeddings in an embedding space that represents data dissimilar from a particular embedding being processed. In some embodiments, the particular embedding being processed is an anchor point.

“Positive query” refers to a determination of one or more sample embeddings in an embedding space that represents data similar to a particular embedding being processed. In some embodiments the particular embedding being processed is an anchor point.

The term “set” refers to at least one data structure that is configured to store any number of data objects of one or more types. A set may be ordered or unordered. “Set of data” refers to a set including any number of data portions.

“Shared identifier” refers to an identifier linked to multiple data portions and/or embeddings.

“Signal data” refers to electronically managed data representing a particular data value for a particular data parameter.

“Signal length” refers to a number of data values in a particular data structure, channel, or time series of data.

“Timestep” refers to a timestamp or time interval that corresponds to at least one data value in a timeseries of data.

“Wearable device” refers to any hardware, software, firmware, and/or a combination thereof that is worn by a user and collects data associated with the user.

### IV. Overview

In various contexts, data values corresponding to various data properties are processed for any of a myriad of downstream purposes. In one particular context, wearable devices worn by a user are utilized to monitor one or more types of biometric data associated with that user. For example, a continuous glucose monitor (CGM) may be worn by the user and utilized to collect glucose levels and/or other biometric data associated with the user at various time intervals as the CGM is worn. Such wearable device and/or other monitoring devices, such as probes and/or the like, may be utilized to generate a robust time series of data of the particular data type. In some contexts, other data associated with the same user may similarly be available at the same and/or other intervals. For example, in some embodiments, the user is associated with an electronic record including one or more ICD codes in an electronic health record corresponding to the user.

In various contexts, it is desirable to use any or all portions of available data to perform determinations and/or otherwise glean particular insights from data of one or more data types and/or combinations of data of various data types. Direct processing of the data, however, may not provide detailed insight into complex relationships derivable from the data. In this regard, in some contexts data embedding using one or more embedding models may be utilized to project such data into a representation of a condensed multi-dimensional space. Such embeddings may represent any number of learned implications, data patterns, trends, and/or other derivations associated with the various data utilized to generate the embeddings. The embeddings may be utilized for any of a myriad of downstream tasks, determinations, and/or the like, for example to make determinations associated with a user based on the embeddings in the embedding space. In this regard, accurate embedding ensures that the downstream determinations and/or other processes are similarly accurate. Traditional embedding mechanisms, however, fail to adequately provide insight into what portions of a data signal (or various data signals) are contributing to a particular feature of a corresponding embedding of such data. In this regard, such mechanisms serve as a black box relative to the embedding as generated. Additionally, traditional embedding mechanisms fail to adequately account for the interactions between data of multiple data types.

Embodiments of the present disclosure utilize attention-based contrastive learning for improved embedding of data of one or more data types. Embodiments of the present disclosure specifically embed one or more portions of data in an embedding and utilize particular attention mechanisms that generate attention masks on a dimension-by-dimension level. These attention masks identify the portions of an input data (e.g., the timepoints in a timeseries signal) that contribute to the learned representation embodied by the embedding. The attention masks and embedding may be combined to generate a modified signal data that is embedded in the embedding space corresponding to the particular input data portions. In this regard, embodiments of the present disclosure generate more accurate models that are less black box and guide model learnings to focus on locations of particular relevant features in portions of input data.

In some embodiments, the model(s) that generate the embeddings utilize a particular implementation of contrastive learning. In some embodiments, the contrastive learning updates the model based on comparisons with other embeddings of a shared identifier. In this regard, the model may be updated to decrease loss in circumstances where such embeddings are more similar. Additionally, the contrastive learning updates the model based on comparisons with other embeddings of a different identifier. In this regard, the model may be updated to increase loss in circumstances where such embeddings are more similar. Such contrastive learning implementations leverage multiple data types to improve the accuracy of the learned embeddings for an entity corresponding to a particular identifier.

Embodiments of the present disclosure provide a myriad of technical improvements and address a myriad of technical problems. Models are configured to accurately determine portions of one or more input data that contribute to embeddings (e.g., learned representations) based on generated attention masks. Such determined portions of input data may be outputted for visualization to enable insight into what portions of a timeseries contribute to a particular embedding. Additionally, use of such attention masks enables configuration of a model to emphasize such portions in updating the learnings of the model to generate embeddings. Additionally still, use of particular contrastive learning enables more accurate learnings during configuration of an embedding model to account for a plurality of data types. In this regard, embodiments of the present disclosure improve the accuracy of the learned representations based on the generated attention masks as well as providing improved explainability of such learned representations.

Other technical improvements and advantages may be realized by one of ordinary skill in the art.

### V. Example Systems Operations

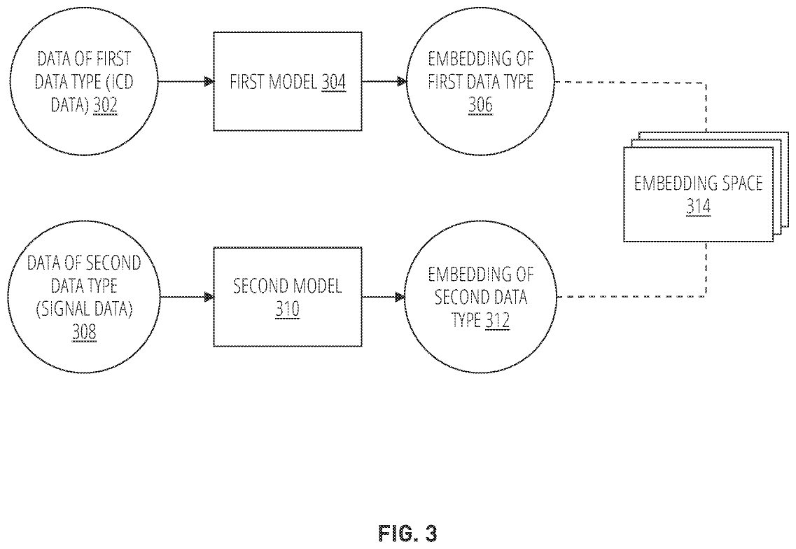

FIG. 3 illustrates a visualization of a data architecture for storing embeddings of a plurality of data types to an embedding space in accordance with at least one embodiment of the present disclosure. Specifically, FIG. 3 depicts generation of different embeddings projected to a shared embedding space 314. The embeddings projected to the embedding space 314 include an embedding 306 of a first data type and an embedding 312 of a second data type. In some embodiments, the embedding computing entity 102 maintains one or more computing environments that support or otherwise maintain the data architecture as depicted and described.

Some embodiments receive data of first data type 302. In some embodiments, the data of first data type 302 embodies ICD data associated with one or more entities, for example corresponding to one or more particular identifiers. For example, the ICD data may include codes associated with a particular entity as parsed, extracted, and/or otherwise determined from at least one electronic health record corresponding to that entity. In some embodiments the data of first data type 302 is received from one or more external devices, databases, and/or the like storing data associated with at least one entity, such as a patient data central repository and/or the like. Additionally or alternatively, in some embodiments, at least one portion of the data of first data type 302 is received directly via user input.

In some embodiments, the data of first data type 302 is processed via a first model 304. The first model 304 in some embodiments embodies a first specially trained machine learning model that generates embeddings for the first data type. For example, in some embodiments, the first model 304 is embodied at least in part by a specially configured neural network that is trained to generate an embedding representing a sequence of clustering values defined in the data of first data type 302. In the context of ICD codes as the first data type, the first model 304 may compress an ICD code and/or any number of ICD codes associated with an entity from the data of first data type 302 to a single vector embodying an embedding 306 associated with the first data type. In some embodiments, all data values in the data of first data type 302 (e.g., ICD codes) for a particular entity are processed to generate corresponding embeddings, and a final embedding is generated by combining the multiple embeddings associated with such data of the data of first data type 302 (e.g., by averaging all such embeddings of the first type for the particular identifier corresponding to an entity). The first data, for example a portion of first data such as ICD code data, may be inputted to the first model for generating a corresponding first embedding using the first model. Non-limiting examples of a first model 304 include a masked transformer model such as BERT, an ICD2Vec model, and/or the like.

The embedding 306 of the first data type represents an individualized vector that compresses or otherwise summarizes the values of the data of first data type 302. In this regard, the embedding 306 may correspond to a reduced dimensionality as compared to the data of first data type 302. For example, in some embodiments, a dimension of the embedding 306 corresponds to a combination of parameters of the data of first data type 302. The embedding 306 is projected in a particular embedding space 314. In this regard, the embedding space 314 may be defined by a particular dimensionality corresponding to the embedding 306 of the first data type.

In some embodiments, the first model 304 is trained based on a training data set including portions of data of the first data type. Additionally or alternatively, in some embodiments, the first model 304 is trained based on a test data set and/or a validation data set. The first model 304 may be trained using any of a myriad of training mechanisms. For example, in some embodiments, the first model 304 is trained using known supervised and/or unsupervised learning techniques. It will be appreciated that in other embodiments, a custom training methodology may be used.

Some embodiments receive data of second data type 308. In some embodiments, the data of second data type 308 embodies signal data associated with one or more entities, for example corresponding to one or more particular identifiers. In some embodiments, at least some of the data of second data type 308 corresponds to one or more shared identifiers as the data of first data type 302.

In some embodiments, the data of the second data type 308 embodies a combined signal. For example, in some embodiments, the combined signal includes a plurality of channels. Each channel may include distinct signal data from a different data source. For example, in some embodiments, the combined signal is generated by assigning data of different wearables, or different data types embodying different monitoring data collected from the same wearable device.

In some embodiments, the data of second data type 308 includes monitored signal data from one or more wearable device associated with a particular user represented by an identifier. In this regard, values for the data of second data type 308 may be collected automatically via one or more sensors worn by an entity. In other embodiments, at least a portion of the data of second data type 308 is inputted via user input, for example by an entity. The data of second data type 308 in some embodiments is received directly from the wearable device(s) associated with such data. Additionally or alternatively, in some embodiments, at least a portion of the data of second data type 308 is received from a database and/or other data warehouse storing such data collected and/or received via the corresponding wearable device. In one example context, the data of second data type 308 includes at least monitoring data from a continuous glucose monitor collected during wearing by a user corresponding to a particular identifier. It should be appreciated that the data of second data type 308 may include different portions of data of the second data type, where such different portions of data correspond to different identifiers for different entities. Additionally or alternatively, in some embodiments, the data of second data type 308 includes a plurality of signal data, for example composited within different channels of a combined signal data of the second data type.

In some embodiments, the data of second data type 308 is processed via a second model 310. The second model 310 in some embodiments embodies a second specially trained machine learning model that generates embeddings for the second data type. For example, in some embodiments, the data of second data type 308 is embodied at least in part by a specially configured neural network that is trained to generate an embedding representing a signal data associated with an identifier during a particular time window. In this regard, in the context of the signal data of a particular wearable device or a combination of signal data of one or more wearable device(s), the second model 310 may compress such signal data and/or different channels thereof associated with a particular entity from the data of first data type 302 into a vector embodying an embedding 312 of the second data type. In some embodiments, multiple different portions of the data of second data type 308 and/or channels thereof are combined for processing by the second model 310, for example by adding, averaging, and/or otherwise combining such multiple portions associated with a particular identifier. Non-limiting examples of a second model 310 include one or more convolutional neural networks (CNNs). In some embodiments, the CNNs includes and/or otherwise is configured to utilize pooling, LSTMs, and/or transformer models.

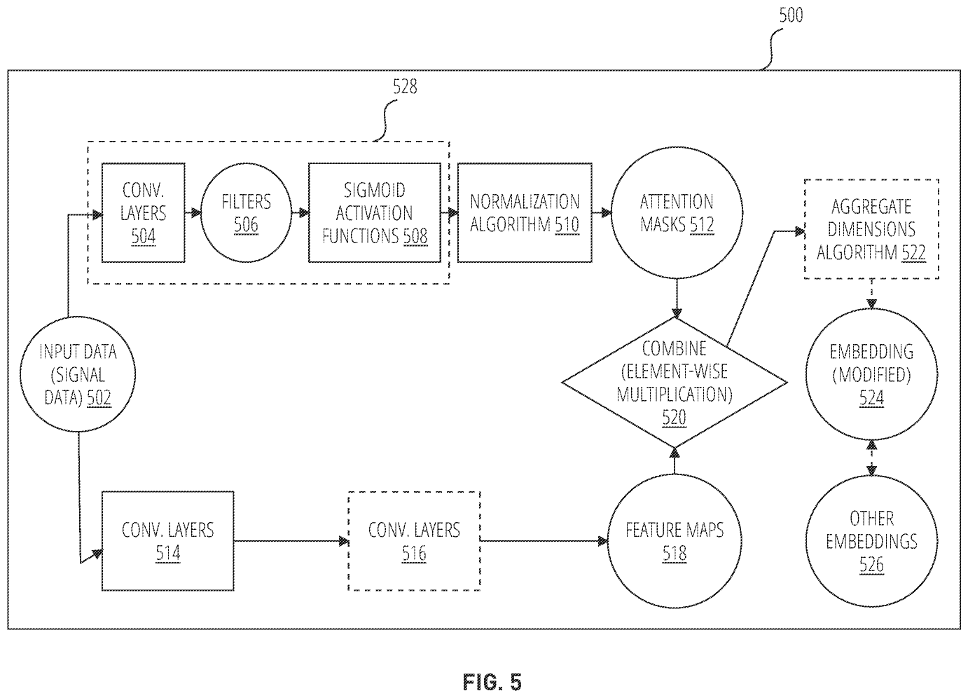

In some embodiments, the second model 310 leverages a specially configured attention mechanism to predict particular portions in a timeseries of input data (e.g., a portion of the data of first data type 302). The attention mechanism identifies and/or isolates particular portions of the input data that the second model 310 utilizes to generate a value for each dimension of the embedding 312 of the second data type. In some embodiments, the attention mechanism includes a specially configured sub-model embodying a convolutional attention network as described herein. In some embodiments, the second model 310 additionally includes a second specially configured sub-model that generates an initial embedding based on input data. In some such embodiments, the first sub-model and the second sub-model may operate simultaneously in parallel to enable simultaneously parallel generation of at least one attention mask and a corresponding initial embedding based on input data, for example at least a portion of the data of second data type 308. The second data, for example a portion of second data such as signal data or combined data composited from a plurality of individual data sources (e.g., different portions of signal data of different data types), may be inputted to the second model for generating a corresponding second embedding using the second model. In some embodiments, the second model 310 is embodied by or includes the models as depicted and described with respect to FIG. 5.

The embedding 312 of the second data type represents an individualized vector that compresses or otherwise summarizes the values of the data of second data type 308. In this regard, the embedding 312 of the second date type may correspond to a reduced dimensionality as compared to the data of second data type 308. For example, in some embodiments, a dimension of the embedding 312 corresponds to a combination of parameters of the data of second data type 308. Specifically, the dimensions of the embedding 312 are based on the attention masks on a dimension-by-dimension level that emphasize particular portions of the data of second data type 308.

The embedding 312 is similarly projected in the embedding space 314. In this regard, the embedding space 314 may be shared for projection via both the first model 304 and second model 310. In this regard, the second model 310 may generate data values for dimensions that map onto particular dimensions of the embedding 306 projected in the embedding space 314. In this regard, embeddings of the first data type and embeddings of the second data type may be determined to represent similar high-level concepts, for example entities that are vulnerable to, diagnosed with, and/or otherwise suffering from certain conditions in the context of medical claims and biometric signal data processing. In this regard, as illustrated, the second model 310 may be configured to generate an embedding corresponding to a second data type where such an embedding is generated with the same number of dimensions as the embedding corresponding to the first data type as generated by the first model 304.

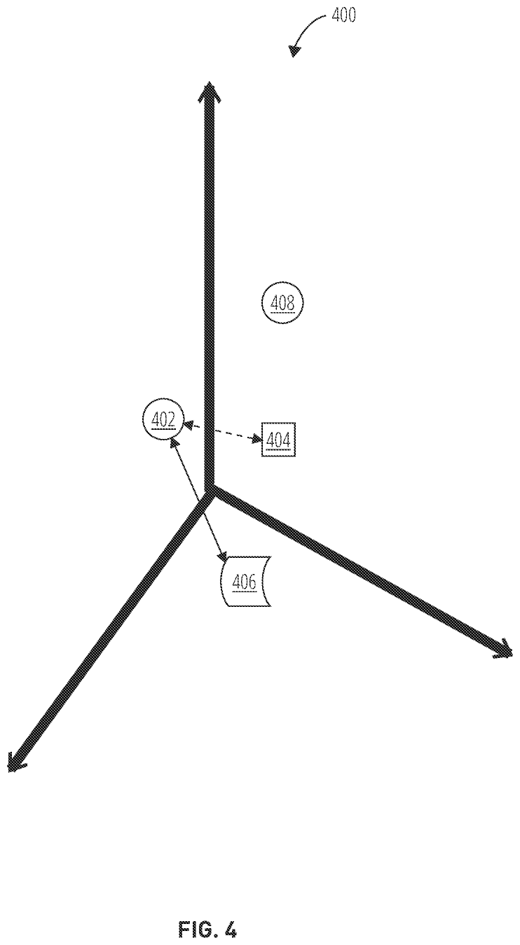

In some embodiments, the second model 310 is trained using contrastive learning. In this regard, the contrastive learning objective may define maintaining similarity between data that is associated with a shared identifier, and minimizing similarity between data that is associated with different identifiers. For example, for a particular shared identifier, the shared identifier may be associated with both a portion of data from the data of first data type 302 and a portion of data from the data of second data type 308. In this regard, the contrastive learning may ensure that a loss function appropriately adjusts a loss as embeddings embedding 312 of the second type are projected based on similarities to one or more of the embeddings 306 of the first data type based on whether such embeddings are for a shared identifier or different identifiers. Non-limiting examples of training the second model using contrastive learning are depicted and described further herein with respect to FIG. 4.

FIG. 4 illustrates a visualization of an embedding space maintaining a plurality of embeddings of different data types in accordance with at least one embodiment of the present disclosure. Specifically, FIG. 4 depicts an embedding space 400 including a plurality of different embeddings, where the embedding space 400 is utilized to perform contrastive learning during training of at least one model. In some embodiments, the embedding space 400 embodies an example implementation of the embedding space 314.

Some embodiments select and/or process particular embeddings within the embedding space 400 to perform contrastive learning based on data values associated with such selected embeddings. For example, as illustrated, the embedding space 400 includes embedding 402, embedding 404, embedding 406, and embedding 408. In some embodiments, the embeddings include embeddings corresponding to different data types. For example, as illustrated, in some embodiments the embedding 402 corresponds to data of a second data type and the embedding 408 correspond to data of the second data type, whereas the embedding 404 and the embedding 406 correspond to a first data type. In one example context, the embedding 402 and embedding 408 embody representations derived from signal data, whereas the embedding 404 and embedding 406 embody representations derived from ICD data. In this regard, it will be appreciated that different models may be utilized to generate the embeddings corresponding to the different data types, for example where a first model is utilized to generate the embedding 404 and the embedding 406, and a second model is utilized to generate each of the embedding 402 and embedding 408.

Additionally, in some embodiments, each of the embeddings is associated with a particular identifier. In some embodiments, the identifier uniquely identifies an entity associated with the data utilized to generate the embedding. For example, as illustrated, the embedding 408, the embedding 404, and the embedding 402 in some embodiments are associated with a first identifier, and the embedding 406 may be associated with a second identifier. In this regard, the embeddings 402, 404, and 408 may be considered associated with a shared identifier, where the shared identifier differs from the second identifier associated with the embedding 406. In one example context, the embedding 402 and the embedding 408 embody embeddings of signal data associated with a first user, the embedding 404 embodies an embedding of ICD data corresponding to the first user, and the embedding 406 embodies an embedding of ICD data corresponding to the second user. It will be appreciated that in some embodiments, any number of embeddings may be projected in the embedding space 400, such that the embeddings depicted in FIG. 4 represent only a subset of the total embeddings within the embedding space 400.

In some embodiments, the various particular embeddings in the embedding space 400 are utilized to perform contrastive learning during training of a particular model. For example, in some embodiments, contrastive learning is utilized to perform training of a model that generates embeddings for signal data, such as data of a second data type collected via a wearable device. As illustrated, for example, one or more embeddings may be compared and utilized to apply a loss based on a loss function. In some embodiments, an embedding of a second data type, for example corresponding to signal data, associated with a particular identifier is compared to at least one embedding of the first data type for the same identifier embodying a shared identifier with one or more embeddings, and/or is compared to at least one embedding of the second data type for at least one other identifier that differs from the shared identifier.

Some embodiments generate an embedding of the second data type (e.g., signal data) for a first identifier, and select a random sample of other identifiers for comparison. Some such embodiments determine embeddings associated with the first data type (e.g., ICD codes) corresponding to each of the identifiers within the random sample of other identifiers. For example, as illustrated, a random sample may identify the other identifier corresponding to the embedding 406 for comparison.

In some embodiments, the contrastive learning process compares the embedding of the second data type for a first identifier with at least one embedding of the first data type corresponding to the first identifier as a shared identifier. Some such embodiments apply a loss function to a model (e.g., the second model embodying a signal embedding model that generates the embeddings of the second data type) that decreases in a circumstance where the embedding of the second data type and the embedding of the first data type associated with the shared identifier are similar. For example, as illustrated, the loss applied to the second model during training using contrastive learning may be decreased as the embedding 402 is generated closer to the embedding 404 by the model.

Additionally or alternatively, in some embodiments the contrastive learning process compares the embedding of the second data type for the first identifier with at least one embedding of the first data type associated with a different identifier. Some such embodiments apply a loss function to a model (e.g., the second model embodying the signal embedding model that generates the embeddings of the second data type) that increases in a circumstance where the embedding of the second data type and the embedding of the first data type associated with different identifiers are similar. For example, as illustrated, the loss applied to the second model during training using contrastive learning may be increased as the embedding 402 is generated closer to the embedding 406. Continuing the example context of an entity embodying an individual patient corresponding to CGM signal data and ICD data, for example, the CGM signal data may be utilized to generate an anchor embedding corresponding to a particular identifier via a signal embedding model being trained via contrastive learning. The resulting anchor embedding may be compared with (i) a first set of embeddings of ICD data also associated with the particular identifier as a shared identifier such that a loss is decreased as the anchor embedding is embedded more similar and/or closer to the embeddings of the first set of embeddings of ICD data, and (ii) a second set of embeddings of ICD data associated with another identifier that is not the particular identifier such that a loss is increased as the anchor embedding is embedded more similar and/or closer to the embeddings of the second set of embeddings of ICD data, where the second set of embeddings of ICD data is randomly selected (e.g., based on randomly selected embeddings and/or randomly selected identifiers differing from the particular identifier corresponding to the anchor embedding). It should be appreciated that the embedding 402 may be compared with a plurality of embeddings corresponding to the shared identifier and/or a plurality of embeddings corresponding to other identifiers during such contrastive learning.

In some embodiments, a particular embedding of the second data type (e.g., signal data, for example CGM signal data) is utilized as an anchor point for purposes of comparison during training of a particular signal embedding model. In some embodiments, a different anchor point is determined for a particular identifier. For example, in some embodiments, an anchor point for a particular identifier is generated based on a combination of embeddings of the second type corresponding to that particular identifier. In one example context, the various embeddings are averaged and/or otherwise combined. As illustrated, for example, the embedding 402 and the embedding 408 in some embodiments are averaged and/or otherwise composited using one or more algorithms to determine a new anchor point associated with the identifier for further comparisons with embeddings corresponding to the first data type for that shared identifier and/or embeddings corresponding to the first data type for other identifiers.

FIG. 5 illustrates visualization of a data architecture of a specially configured model during training of the model in accordance with at least one embodiment of the present disclosure. Specifically, FIG. 5 depicts a data architecture for training of a particular model 500 for a second data type in various embodiments, for example a signal embedding model associated with accurately embedding particular signal data. For example, in some embodiments, the specially configured model 500 embodies an example of the second model 310 as depicted and described herein.

In some embodiments, data for processing by the particular model 500 is received. As illustrated, in some embodiments the data includes input data 502. In some embodiments, the input data 502 includes a set of data collected via any number of wearable devices. In some embodiments, the input data 502 includes or embodies signal data associated with a particular wearable device, such as glucose monitoring data associated with a continuous glucose monitor. Additionally or alternatively, in some embodiments, each portion of the input data 502 includes a plurality of channels, where each channel includes a vector or sub-set of data for processing. For example, in some embodiments, the input data 502 includes a first channel including a primary signal of a first data type collected via a first computing device, such as via a first wearable device and/or first one or more sensors, and the input data 502 includes a second channel including at least one secondary signal of a different data type collected via a second computing device, such as via a second wearable device and/or second one or more sensors. In some embodiments the input data 502 is generated by compositing each different portion of signal data defined across the same time interval into each channel of the input data 502, where the channel corresponds to the time interval.

As illustrated, the signal embedding model includes a separate sub-model embodying an attention mechanism using one or more layers separate from a second separate sub-model including one or more other layers that generate feature maps used in generating an embedding. For example, in some embodiments, the model 500 includes one or more convolutional attention networks 528, each including any number of convolutional attention network layers. In some embodiments, the model 500 includes a convolutional attention network for each embedding dimension to be generated, for example based on a corresponding embedding of another type and/or information regarding an embedding space within which the input signal 502 is to be projected. In some embodiments, the model 500 includes a convolutional attention network including one or more layers for each embedding dimension associated with an embedding space. For example, in a circumstance where an embedding space for embedding a first data type includes X dimensions, where X is a number, the model may include X convolutional attention networks. Each such convolutional attention network may correspond to a particular dimension of the X dimensions. In this regard, the embeddings corresponding to the distinct embedding types may include the same number of dimensions. In other embodiments, each dimension may be associated with a plurality of convolutional attention networks. FIG. 5 depicts an example convolutional attention network including convolutional layer 504 that generate any number of filters 506 applied to one or more sigmoid activation functions 508 and/or normalization algorithm 510.

Each convolutional attention layer may include at least one convolutional layer 504. In some embodiments, the at least one convolutional layer 504 embodies or includes a series of convolutional neural network layers arranged with one another to process the input data 502. Each convolutional layer of the at least one convolutional layer 504 generates at least one filter 506. In this regard, the at least one filter 506 represents any number of feature maps generated by any of the at least one convolutional layers 504. It will be appreciated that each convolutional layer may generate a particular filter, or a plurality of filters, embodying the one or more feature maps generated via said convolutions. A particular filter in some embodiments represents features that contribute to the activations of the corresponding convolutional layer. In some embodiments, the at least one filter 506 includes a distinct filter for each dimension of an embedding to be generated. In one such example, the number of dimensions is determined corresponding to a number of dimensions utilized in embeddings of another data type in the embedding space, for example code data, ICD data, and/or the like.

The at least one filter 506 is provided to any number of sigmoid activation functions 508. The sigmoid activation functions 508 in some embodiments bounds the activations of the at least one filter 506 within a particular range of values, for example between 0 and 1. In some embodiments, the sigmoid activation functions 508 includes a sigmoid activation function applied for each timestep of the original input data 502 being processed.

The results of the sigmoid activation functions 508 in some embodiments are applied to normalization algorithm 510. The normalization algorithm 510 in some embodiments normalize the values of the inputs applied to the normalization algorithm 510 to sum such values to one over all timesteps of the input data 502. In this regard, the sigmoid activation functions 508 are processed via the normalization algorithm 510 to generate attention masks 512, the attention masks 512 representing a particular attention mask for each dimension of an embedding of the input data 502 to be generated.

As illustrated, the attention masks 512 may include a generated attention mask for each timestep having a particular weight per timestep of the original input signal. In some embodiments, the attention mask 512 is combined to force the model 50 to emphasize or otherwise focus its attention on specific portions of the input signal when generating outputs embodying each dimension of the embedding corresponding to the input signal.

In parallel with the first sub-model embodying the leg of the model 500 that generates the attention masks 512, the model 500 includes a second leg that processes the input data 502 to generate one or more feature maps. As illustrated, for example, the input data 502 is inputted to one or more other convolutional layers 514. Optionally, the one or more convolutional layers 514 may be followed by any number of additional convolutional layers 516. The convolutional layers 514 alone, and/or the convolutional layers 514 in combination with any number of the optional additional convolutional layers 516, generates feature maps 518 from processing the input data 502. In some embodiments, the convolutional layers 514 and/or any of the optional additional convolutional layers 516 include any number of convolutional layers that are each configured to receive the same input signal length and generate the same output signal length. In this regard, a particular convolutional layer in some embodiments adds padding and/or other data to each portion of generated output data to ensure that the output signal length generated by a particular convolutional layer remains the same as the input signal length received by that convolutional layer.

In some embodiments, the input data 502 is combined with the attention masks 512 to generate modified signal data for processing. For example, in some embodiments, the input data 502 is combined with the attention masks 512 via element-wise multiplication. The element-wise multiplication generates a modified signal data that forces emphasis on particular portions of the input data 502, while generating an output for each desired embedding dimension. For example, in some embodiments the modified is processed by the convolutional layers 514 and/or convolutional layers 516 to generate the feature maps 518.

As illustrated, the attention masks 512 and the feature maps 518 are applied to combination algorithm 520. In some embodiments, the combination algorithm 520 generates one or more combined data values from an element-wise combination of the attention masks 512 and feature maps 518. In some embodiments, the combination algorithm 520 embodies an element-wise multiplication algorithm that combines the attention masks 512 with the feature maps 518.

In some embodiments, the output of the combination algorithm 520 is optionally processed by an aggregate dimension's algorithm 522. In some embodiments, the output of the combination algorithm 520 is processed in a circumstance where a plurality of attention masks is generated per dimension of the embedding to be generated. For example, in some embodiments, the plurality of attention masks for a particular dimension are combined using an aggregate dimension's algorithm 522 that embodies a mean aggregation algorithm, a sum aggregation algorithm, a max value aggregation algorithm, and/or the like. In some embodiments where the attention masks 512 includes only a single attention mask per dimension, no aggregate dimension's algorithm 522 may be performed.

The dimension values from the combination algorithm 520, and/or aggregated dimension values from the aggregate dimension's algorithm 522, may be utilized to generate a particular embedding 524. In this regard, in some embodiments each dimension generated corresponds to a particular dimension of an embedding of another data type. In one example context, the embedding 524 includes dimensions for signal data determined by the model 500 that each correspond to a dimension of another embedding of ICD data in an embedding space shared between such embeddings. In this regard, the embedding 524 embodies an embedding of the input data 502 modified to emphasize particular portions of the input data 502 that contribute to the specific dimensions determined by the model 500 as embodying the representation of the input data 502.

In some embodiments, the embedding 524 is trained using contrastive learning. For example, as illustrated, the embedding 524 in some embodiments is generated via contrastive learning with one or more other embeddings 526. The other embeddings 526 in some embodiments includes one or more embeddings in an embedding space shared with the embedding 524. The other embeddings 526 may include one or more positive query embeddings that should be similarly proximate to the location of the embedding 524 in the embedding space, and/or one or more negative query embeddings that should not be proximate to the location of the embedding 524. In this regard, in some embodiments the positive query embeddings include one or more embeddings of the other embeddings 526 associated with the shared identifier representing the same identifier associated with the embedding 524, such that the loss function of the model 500 is trained to decrease loss as such embeddings are closer together. Additionally or alternatively, in some embodiments, the negative query embeddings include one or more embeddings of the other embeddings 526 associated with a different identifier than the identifier associated with the embedding 524 such that the loss function of the model 500 is trained to increase loss as such embeddings are closer together. In this regard, the model 500 in some embodiments is trained in accordance with FIG. 4.

In this regard, it will be appreciated that FIG. 5 depicts a specific embedding model that includes two legs that operate in parallel. The first leg performs generation of attention masks from input data on a dimension-by-dimension level, where the first leg is embodied by the elements described above with respect to reference characters 504-512. The second leg performs generation of feature maps from the input data, where the second leg is embodied by the elements described with respect to reference characters 514-518. These legs of the model are trained in parallel, and then the feature maps and attention masks are combined to generate the final values for each dimension or may generate multiple data values that are aggregated to combine into a single value for a given dimension. A final embedding of the input data is then generated as a composite of the value for each dimension.

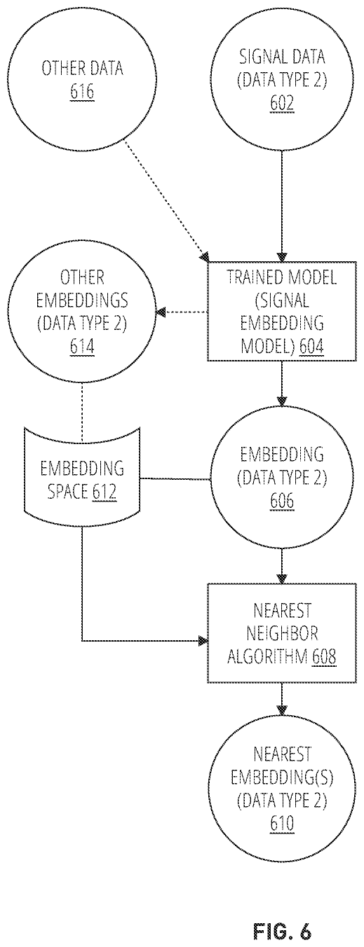

FIG. 6 illustrates a visualization of a data architecture for initiating a first downstream process based on the improved trained models in accordance with at least one embodiment of the present disclosure. Specifically, FIG. 6 depicts a data architecture that identifies one or more nearest embeddings using at least one model trained as depicted and described herein. For example, in some embodiments at least one nearest embedding is determined using a second model embodying a trained signal embedding model trained as depicted and described with respect to FIG. 3-FIG. 5. The initiation of a downstream process may occur on the same system that performs the training of the at least one model, and/or a different system that deploys the at least one model after completion of the training.

As illustrated, some embodiments receive signal data 602. The signal data 602 is embodies data of a second data type. For example, in some embodiments, the signal data 602 embodies monitoring data received or otherwise collected via one or more sensors or other inputs of a wearable device. In this regard, in some embodiments the signal data 602 includes time series data and/or one or more data values across a particular interval of one or more timesteps.

In some embodiments, the signal data 602 is processed alone. Additionally or alternatively, in some embodiments, the signal data 602 is processed together with at least one other portions of data of another data type. For example, in some embodiments, other data 616 is received embodying other signal data from the same time interval of the signal data 602, and/or other supporting data associated with one or more identifiers and/or the like. In some embodiments, the other data 616 includes one or more portions of other monitoring data embodying signal data captured via the same wearable device as the signal data 602 and/or a different wearable device associated with the same identifier, for example a particular patient.

The signal data 602 alone and/or the other data 616 are applied to the trained model 604. In some embodiments, the trained model 604 embodies a signal embedding model trained to embed one or more portions of data in an embedding space as described herein, specifically the embedding space 612. For example, in some embodiments the trained model 604 is trained as depicted and described herein with respect to FIG. 3-FIG. 5. In this regard, the trained model 604 may generate dimensions that embodies an embedding 606. It should be appreciated that the embedding 606 is an embedding of a particular data type, for example corresponding to the data type 2 representing a data type associated with the signal data 602. In this regard, in some embodiments the signal data 602 includes one or more portions of signal data.

In some embodiments, the trained model 604 additionally is utilized to project one or more other embeddings 614 in the same embedding space, particularly embedding space 612. For example, in some embodiments, the other embeddings 614 represent embeddings projected and/or otherwise generated based on other portions of signal data of data type 2 similarly applied to and processed by the trained model 604. Continuing the example context where the signal data 602 embodies monitoring data from a continuous glucose monitor or other wearable device, the data portions corresponding to the other embeddings 614 represent monitoring data collected during a different timestamp interval and/or for other identifiers. In some such embodiments, at least one portion of the signal data 602 is applied to the trained model for embedding, where the trained model 604 embodies a second model trained as depicted and described with respect to FIG. 5. It will be appreciated that, in this regard, the embedding space 612 may include embeddings for any number of distinct identifiers. For example, as described herein, a machine learning model in some embodiments is specially trained to generate a generate a second embedding, such that embodiments update the embedding space to include the second embedding as generated.

The embedding 606 is processed to initiate one or more downstream processes. In some embodiments, the embedding space 612 is processed to determine embeddings of a particular type that are determined to be similar to a particular target embedding. For example, some embodiments process the generated embedding 606 to determined other similar embeddings of the same data type. As illustrated, embeddings of the embedding space 612 are applied to the nearest neighbor algorithm 608. In some embodiments, the nearest neighbor algorithm 608 includes or is embodied by one or more algorithmic, statistical, and/or machine learning model. In this regard, the nearest neighbor algorithm 608 may process the embedding space 612 to identify a particular set of nearest embeddings from the other embeddings 614 that are nearest to the embedding 606 in the embedding space 612. In some embodiments, the nearest neighbor algorithm 608 identifies any number of the other embeddings 614 within the embedding space 612 that are nearest to the embedding 606 and of the same data type (e.g., data type 2). In some embodiments, the nearest neighbor algorithm 608 embodies any known K-nearest neighbors' algorithm.

The nearest neighbor algorithm 608 generates and/or outputs the nearest embeddings 610. In some embodiments, the nearest embeddings 610 embody any number of embeddings corresponding to the same data type as embedding 606, and which may correspond to one or more other identifiers distinct from the identifier associated with the embedding 606. In this regard, the nearest embeddings 610 in some embodiments represent embeddings corresponding to identifiers representing other entities that have had similar patterns of signal data 602 corresponding to the embedding 606, such that derivations and/or determinations may be made based on other data associated with such other identifiers. In one example context, such nearest embeddings 610 correspond to other identifiers representing other patients that have had similar windows of signal data corresponding to the embedding 606, and therefore such identifiers may be utilized to determine other diagnoses, treatments, outcome trajectories, and/or other data associated with such other patients represented by these identifiers. Additionally or alternatively, in some embodiments, the nearest embeddings 610 may include one or more other embeddings corresponding to the same identifier as embedding 606, such that similar windows of signal data are identified for comparison, outputting, and/or further processing.

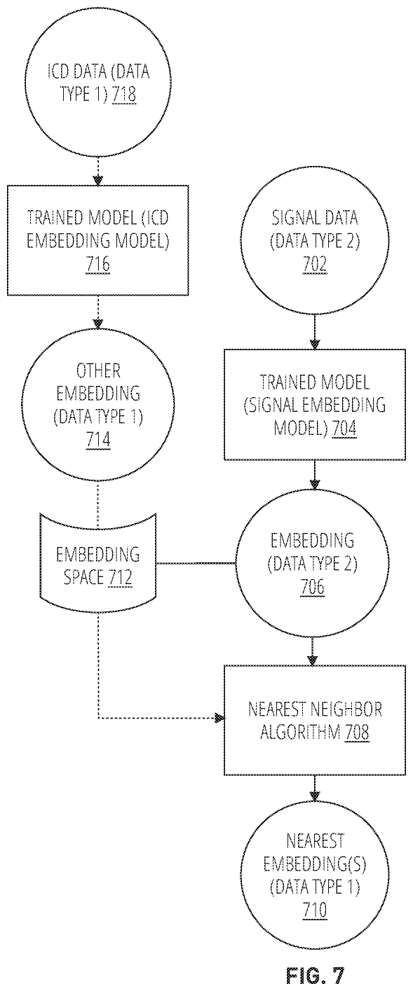

FIG. 7 illustrates a visualization of a data architecture for initiating a second downstream process based on the improved trained models in accordance with at least one embodiment of the present disclosure. Specifically, FIG. 7 depicts a data architecture that identifies one or more nearest embeddings using at least one model trained as depicted and described herein. For example, in some embodiments at least one nearest embedding is determined using a first model embodying an embedding model for a first data type and a second model embodying a trained signal embedding model of a second data type, such models trained as depicted and described with respect to FIG. 3-FIG. 5 herein. The initiation of a downstream process may occur on the same system that performs the training of the at least one model, and/or a different system that deploys the at least one model after completion of the training.

As illustrated, some embodiments receive signal data 702. The signal data 702 embodies data of a second data type. For example, in some embodiments, the signal data 702 embodies monitoring data received or otherwise collected via one or more sensors or other inputs of a wearable device. In this regard, in some embodiments the signal data 702 includes time series data and/or one or more data values across a particular interval of one or more timesteps. In some embodiments, the signal data 702 is processed alone. Additionally or alternatively, in some embodiments, the signal data 702 is processed together with one or more other portions of data, for example other monitoring data as described herein. In some embodiments, the signal data 702 is embodied by the signal data 602 as depicted and described with respect to FIG. 6.

The signal data 702 is applied to the trained model 704. In some embodiments, the trained model 704 embodies a signal embedding model trained to embed one or more portions of data in an embedding space as described herein, specifically the embedding space 712. For example, in some embodiments, the trained model 704 is trained as depicted and described herein with respect to FIG. 3-FIG. 5. In this regard, the trained model 704 may generate dimensions that embody the embedding 706. It should be appreciated that the embedding 706 is an embedding of a particular data type, for example corresponding to the data type 2 representing a data type associated with the signal data 702.

Some embodiments further receive data of another data type, for example ICD data 718. The ICD data 718 may represent a distinct data type, for example data type 1 as illustrated. The signal data 702 and/or each portion of ICD data 718 may be associated with a particular identifier with which such data is associated. For example, in one example context, the ICD data 718 embodies clinical notes and/or code data corresponding to one or more identifiers representing patients. In this regard, the clinical data and/or code data may be submitted by one or more other systems distinct from the wearable device and/or computing device utilized to input the signal data 702. Additionally or alternatively, in some embodiments, the ICD data 718 includes data portions that are more temporally spaced than the data collection represented by the signal data 702. For example, in some embodiments, the ICD data 718 includes data portions that each represent, for a particular identifier, electronic healthcare record data for a patient corresponding to that particular identifier and that is updated subsequent to each medical event visit that the patient undergoes. The ICD data 718 may include portions of data corresponding to the same shared identifier.

As illustrated, the ICD data 718 is applied to the trained model 716. In some embodiments, the trained model 716 embodies an ICD embedding model trained to embed one or more portions of data of a distinct data type to that of trained model 704 in an embedding space as described herein. Specifically, the trained model 716 as illustrated embeds each portion of the ICD data 718 in the embedding space 712. In this regard, the embedding space 712 is shared between the embeddings of a first data type and embeddings of a second data type, for example embeddings trained model 716 and embedding 706 respectively, for any number of identifiers. In one example context, for example, the embedding space 712 includes at least one other embedding 714 that embodies a projected representation of codes, diagnoses, and/or other data values in the ICD data 718 together with embedding 706 that embodies a projected representation of the signal data values for one or more shared identifiers, and/or signal data values for one or more distinct identifiers. In some embodiments, the trained model 716 embodies any known algorithmic, statistical, and/or machine learning model configured to embed representations of data in a particular embedding space based on data values of such data.

In some embodiments, the embedding space 712 is processed to determine embeddings of a first data type that are determined to embeddings of a second data type. For example, some embodiments process the generated embedding 706 to determine other, similar embeddings of the other embeddings 714 corresponding to the first data type. As illustrated, embeddings of the embedding space 712 are applied to the nearest neighbor algorithm 708. In some embodiments, the nearest neighbor algorithm 708 includes or is embodied by one or more algorithmic, statistical, and/or machine learning model. In this regard, the nearest neighbor algorithm 708 may process the embedding space 712 to identify a particular set of nearest embeddings of the first type from the other embedding 714 that are nearest to the embedding 706 in the embedding space 712. In some embodiments, the nearest neighbor algorithm 708 identifies any number of the other embeddings 714 within the embedding space 712 that are nearest the embedding 706 and of a distinct data type (e.g., data type 1). In some embodiments, the nearest neighbor algorithm 708 embodies any known K-nearest neighbors' algorithm.

The nearest neighbor algorithm 708 generates and/or outputs the nearest embeddings nearest embedding 710. In some embodiments, the nearest embedding 710 embody any number of embeddings corresponding to a distinct data type from the embedding 706, and which may correspond to one or more identifiers distinct from the identifier associated with the embedding 706. In this regard, the nearest embedding 710 in some embodiments represent embeddings corresponding to one or more other identifiers distinct from the identifier associated with the embedding 706. In this regard, the nearest embedding 710 in some embodiments represent embeddings of electronic health record codes corresponding to identifiers representing other entities that are determined to be medically relevant to a particular identifier based on the location of the embedded signal data 702 corresponding to that particular identifier. In this regard, in one example context, the medical histories of identifiers corresponding to particular patients may be identified and/or determined based on the other embedding 714, and utilized to determine, derive, and/or otherwise intuit similar medical circumstances are associated with the patient represented by the identifier corresponding to the embedding 706. Therefore, such identifiers associated with the nearest embedding 710 embodying one or more other embeddings 714 determined proximate to the embedding 706 may be utilized to determine other diagnoses, treatments, outcome trajectories, medical histories, and/or other data associated with such other patients represented by these identifiers. In this regard, the nearest embedding 710 may include one or more other embeddings corresponding to distinct identifiers that are distinct from the embedding 706, such that identifiers associated with data representing medical circumstances, particular diagnoses, and/or the like deemed similar to signal data corresponding to the embedding 706 for further comparison, outputting, and/or further processing.

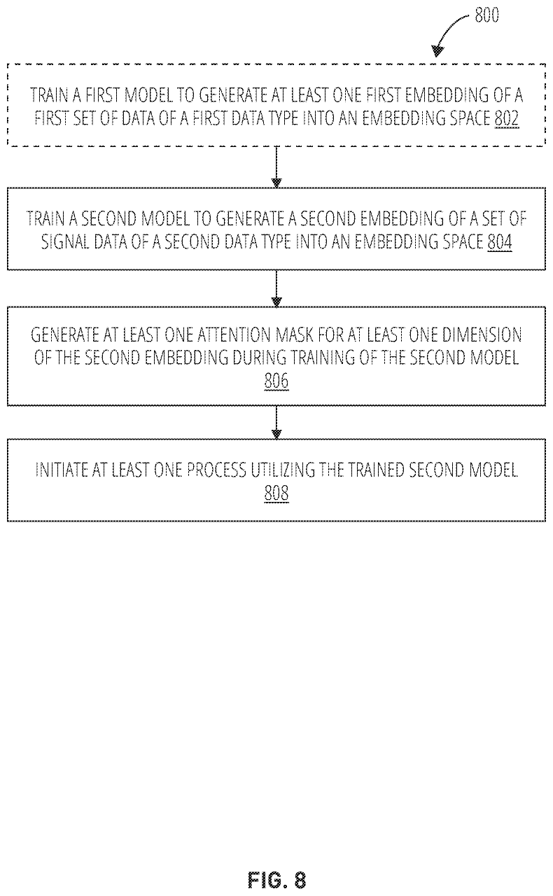

FIG. 8 illustrates a flowchart depicting example operations of a process in accordance with at least one embodiment of the present disclosure. Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at the same time or substantially the same time, or in a specific sequence.

The blocks indicate operations of each process. Such operations may be performed in any of several ways, including, without limitation, in the order and manner as depicted and described herein. In some embodiments, one or more blocks of any of the processes described herein occur in between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted blocks are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

FIG. 8 specifically depicts a process 800. The process 800 embodies an example computer-implemented method. In some embodiments, the process 800 is embodied by computer program code stored on a non-transitory computer-readable storage medium of a computer program product configured for execution to perform the process as depicted and described. Alternatively, or additionally, in some embodiments, the process 800 is performed by one or more specially configured computing devices, such as the specially configured servers and/or apparatuses depicted and/or described herein alone or in communication with one or more other component(s), device(s), system(s), and/or the like. In this regard, in some such embodiments, such that at least one computing device is specially configured by computer-coded instructions (e.g., computer program instructions) stored thereon, for example in a memory element and/or another component depicted and/or described herein and/or otherwise accessible to the computing device, for performing the operations as depicted and described. In some embodiments, the computing device is in communication with one or more external apparatus(es), system(s), device(s), and/or the like, to perform one or more of the operations as depicted and described. In some embodiments, the computing device is in communication with separate component(s) of a network, external network(s), and/or the like, to perform one or more of the operations as depicted and described. For purposes of simplifying the description, the process 800 is described as performed by and from the perspective of a specially configured apparatus configured to support an embedding computing entity 102 as depicted and described herein.

According to some examples, the method includes training a first model to generate at least one first embedding of a first set of data of a first data type in an embedding space at optional operation 802. In some embodiments, the first data type represents non-signal data associated with one or more identifiers. In some embodiments, the first set of data includes data that is received associated with a particular identifier at sporadic or otherwise infrequent time intervals as compared to a second data type. In one example context, the first set of data includes ICD data and/or other code data of an electronic health record associated with each patient of any number of patients, each patient represented by an identifier. In some embodiments, the first set of data is received from an external system, data warehouse or repository, and/or other computing entity that enables inputting, storing, and/or other collecting of data associated with one or more identifiers.

According to some examples, the method includes training a second model to generate a second embedding of a set of signal data of a second data type in an embedding space at operation 804. In some embodiments, the second data type corresponds to signal data associated with at least one identifier. In some embodiments, the set of signal data includes signal data embodying monitoring data captured by at least one wearable device at particular intervals. In some embodiments, a wearable device worn by an entity represented by a particular identifier is utilized to capture signal data at particular time intervals, the captured signal data associated with the identifier corresponding to the entity. In some embodiments, the set of signal data includes multiple data types, each captured by the same wearable device, or captured via a combination of multiple different wearable devices.

In some embodiments, the embedding space is shared between the first model and the second model. In this regard, the embeddings generated by the first model may be defined based on data values for each of any number of dimensions learned by the first model to accurately represent the set of data of the first data type. Each embedding of the second data type, for example a portion of signal data from the set of signal data, may be mapped in the same embedding space such that an embedding associated with signal data determined to represent similar characteristics corresponding to particular values for one or more of the dimensions are similarly projected in the embedding space. In this regard, the embedding space may be configured to include one or more first embeddings corresponding to the first data type and configured to include one or more second embeddings corresponding to the second data type. For example the first model generates an embedding of a portion of signal data in the embedding space and a second model generates an embedding of a portion of second data (e.g. of another data type) in the embedding space upon inputting of such data to the respective model.

Each embedding may correspond to a particular identifier. In this regard, the embedding space may maintain a plurality of embeddings corresponding to a plurality of distinct identifiers. Additionally or alternatively, in some embodiments, the embedding space maintains multiple embeddings associated with a particular shared identifier. For example, in some embodiments, the embedding space maintains embeddings corresponding to multiple portions of signal data corresponding to the same shared identifier, such as embeddings of different portions sampled across distinct timesteps. Additionally or alternatively, in some embodiments, the embedding space maintains embeddings corresponding to multiple different portions of the set of data of the first data type corresponding to the same shared identifier, such as embeddings of different codes in an electronic health record for a patient represented by the same shared identifier. Additionally or alternatively still, in some embodiments it should be appreciated that the embedding space may be configured to include one or more embeddings of data of a first data type and one or more embeddings of data of a second data type that both correspond to same shared identifier.

In some embodiments, the second model is trained based at least in part using contrastive learning as depicted and described herein. For example, in some embodiments, the second model is trained via contrastive learning based on comparison of an embedding generated by the second model with one or more other embeddings in the embedding space. In some such embodiments, the implementation of contrastive learning trains the second model such that a loss function is adjusted to decrease when generating an embedding for a particular identifier that is nearby other embeddings of the particular identifier as a shared identifier between such embeddings. Additionally or alternatively, the implementation of contrastive learning trains the second model such that a loss function is adjusted to increase when generating an embedding for a particular identifier that is nearby other embeddings corresponding to other, distinct particular identifiers (e.g., not the same shared identifier). In some embodiments, the contrastive learning is performed as described herein with respect to FIG. 3-FIG. 5.

According to some examples, the method includes generating at least one attention mask for at least one dimension of the second embedding during training of the second model at operation 806. For example, in some embodiments the second model includes a first set of layers trained in parallel together with a second set of layers embodying a convolutional attention network based on the same input. In some embodiments, at least one attention mask is generated per each dimension of an embedding generated by the second model. In this regard, at least one attention mask may be generated for each dimension, wherein the at least one attention mask corresponding to a particular dimension is configured to emphasize particular portions of an inputted portion of signal data that particularly contributes to the value of that dimension generated via embedding. The at least one attention mask and one or more feature maps for a particular input portion of data (e.g., signal data) may be combined to generate a more accurate embedding for such input data. In some embodiments, the at least one attention mask embody a set of attention masks generated using a dimension attention mechanism in parallel with training of the second model, as described herein with respect to FIG. 3-FIG. 5.

According to some examples, the method includes initiating at least one process using the trained second model at operation 808. In some embodiments, the at least one process embodies a downstream process that utilizes the trained second model to embed newly identified signal data for comparison with embeddings of data of the second data type to identify one or more nearest embeddings to an embedding of the newly received signal data. In this regard, the nearest embeddings may represent embeddings of signal data for the same, shared identifier and/or nearest embeddings that represent embeddings of signal data for one or more other, distinct identifiers corresponding to other entities. Additionally or alternatively, in some embodiments, the at least one process embodies a downstream process that utilizes the trained second model to embed newly identified signal data for comparison with embeddings of data of the first data type to identify one or more nearest embeddings to an embedding of the newly received signal data. In this regard, the nearest embeddings may represent embeddings of other, non-signal data for the same, shared identifier and/or nearest embeddings that represent embeddings of other non-signal data for one or more other, distinct identifiers. The identifier corresponding to each nearest embeddings may represent a particular entity determined to be associated with one or more characteristics, circumstances, diagnoses, determinations, and/or the like that are similar to the characteristics, circumstances, diagnoses, determinations, and/or the like for a particular other identifier corresponding to the new embedding. Non-limiting examples of the at least one processor using the trained second model are depicted and described herein with respect to FIG. 6-FIG. 7.

In some embodiments, the process utilizing the trained second model comprises use of the trained second model to generate and subsequent utilize an embedding of at least a portion of signal data. Such a process may be implemented by an embodiment independently, or in some embodiments follows subsequent to operations as depicted and described with respect to the process 800.

Some embodiments optionally receive a portion of signal data embodying subsequent data signals or processing. In some embodiments, the portion of signal data is identified, retrieved, or predetermined.

Some embodiments generate a second embedding based on a portion of signal data in an embedding space using a second model. The second model embodies the trained second model described herein, for example representing a signal embedding model associated with one or more particular data signals. In some such embodiments, the embedding space is shared with a first embedding generated based on a portion of first data in the embedding space using a first model. In some embodiments, the first model embodies another embedding model specially trained to embed a different data type in the embedding space. For example, in some embodiments, the first model and the second model embody the models as depicted and described with respect to FIG. 3.

Additionally or alternatively, in some embodiments, the portion of first data comprises a first data type and the portion of signal data comprises a second data type. In this regard, the first model and the second model may be specially configured to handle the distinct data types.

Additionally or alternatively, in some embodiments, the second model is trained at least in part using contrastive learning of the first data type and the second data type. For example, in some embodiments, the second model is trained as described herein based at least in part on a loss function that increases as embedding of a portion of signal data of the second type is closer to embeddings of other data of the first type, such as ICD code data, for the same shared identifier and/or decreases as embedding of the portion of signal data of the second type is closer to the embeddings of the other data of the second type. In some embodiments, the second model is trained as described with respect to FIG. 3-FIG. 8 herein.

Additionally or alternatively, in some embodiments the second model identifies one or more attention masks for one or more dimensions of the second embedding and generates the second embedding based on the one or more attention masks. For example, in some embodiments the one or more attention masks are generated as part of a first leg of the trained second model. In some embodiments, the one or more attention masks are generated based at least in part on input data including the portion of signal data, for example via the model as depicted and described with respect to FIG. 5.

Additionally or alternatively, some embodiments initiate a process based on the second embedding. For example, in some embodiments, the process embodies or includes one or more of the processes described with respect to FIG. 6 and/or FIG. 7 herein. In some embodiments, the process includes comparing the generated second embedding with one or more other embeddings, for example associated with a first data type or a second data type, via a nearest neighbor algorithm. Some such embodiments identify one or more nearest embeddings that are to be outputted and/or processed for further derivations, such as to identify data associated with identifier(s) corresponding to the nearest embeddings.

### VI. Conclusion

Embodiments of the present disclosure can be implemented in various ways, including as computer program products that comprise articles of manufacture. Such computer program products can include one or more software components including, for example, software objects, methods, data structures, or the like. A software component can be coded in any of a variety of programming languages. An illustrative programming language can be a lower-level programming language such as an assembly language associated with a particular hardware architecture and/or operating system platform. A software component comprising assembly language instructions can require conversion into executable machine code by an assembler prior to execution by the hardware architecture and/or platform. Another example programming language can be a higher-level programming language that can be portable across multiple architectures. A software component comprising higher-level programming language instructions can require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages can be executed directly by an operating system or other software component without having to be first transformed into another form. A software component can be stored as a file or other data storage construct. Software components of a similar type or functionally related can be stored together such as, for example, in a particular directory, folder, or library. Software components can be static (e.g., pre-established, or fixed) or dynamic (e.g., created or modified at the time of execution).

A computer program product can include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium can include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium can also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium can also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a nonvolatile computer-readable storage medium can also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium can include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media can be substituted for or used in addition to the computer-readable storage media described above.

As should be appreciated, various embodiments of the present disclosure can also be implemented as methods, apparatus, systems, computing devices, computing entities, and/or the like. As such, embodiments of the present disclosure can take the form of an apparatus, system, computing device, computing entity, and/or the like executing instructions stored on a non-transitory computer-readable storage medium to perform certain steps or operations. Thus, embodiments of the present disclosure can also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations can be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a non-transitory computer-readable storage medium for execution. For example, retrieval, loading, and execution of code can be performed sequentially such that one instruction is retrieved, loaded, and executed at a time. In some exemplary embodiments, retrieval, loading, and/or execution can be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, VII. Examples

Example 1. A computer-implemented method including: generating, by one or more processors and via a machine learning model, a second embedding having a same number of dimensions as a first embedding of a first data having a first data type, where the portion of first data comprises a first data type, where the portion of signal data comprises a second data type, where the machine learning model is trained at least in part using contrastive learning of the first data type and the second data type, and where the second model identifies one or more attention masks for one or more dimensions of the second embedding and generates the second embedding based on the one or more attention masks; updating, by the one or more processors, the embedding space to include the second embedding; and initiating a process based on the second embedding.

Example 2. The computer-implemented method of any of the preceding examples, further including: training the second model to generate the second embedding of the signal data in the embedding space; and generating the at least one attention mask for the one or more dimensions of the second embedding during training of the second model.

Example 3. The computer-implemented method of any of the preceding examples where the portion of first data comprises international classification of disease code data associated with one or more identifiers.

Example 4. The computer-implemented method of any of the preceding examples where the first model comprises a neural network.

Example 5. The computer-implemented method of any of the preceding examples, further including: training another machine learning model to generate the first embedding of the portion of first data in the embedding space.

Example 6. The computer-implemented method of any of the preceding examples where the portion of first data comprises a data record embodying a combination of data portions associated with a shared identifier.

Example 7. The computer-implemented method of any of the preceding examples, where the set of signal data comprises monitoring data collected by a wearable device worn by a patient.

Example 8. The computer-implemented method of any of the preceding examples where the monitoring data comprises data signals from a continuous glucose monitor.

Example 9. The computer-implemented method of any of the preceding examples where the portion of signal data comprises a combined signal comprising a plurality of channels that each correspond to a different data type of a plurality of different data types.

Example 10. The computer-implemented method of any of the preceding examples where generating the second embedding includes: inputting the portion of signal data in parallel to each of a convolutional neural network and a convolutional attention network, where the convolutional attention network generates the one or more attention masks for the one or more dimensions of the second embedding, and where the second embedding is based on a combination of the one or more attention masks and a feature map generated by the convolutional neural network.

Example 11. The computer-implemented method of any of the preceding examples where the convolutional neural network comprises any number of convolutional layers, each convolutional layer comprising the same input signal length and output signal length.

Example 12. The computer-implemented method of any of the preceding examples where the convolutional attention network comprises any number of convolutional layers that generates output processed via a sigmoid activation function, and where the convolutional attention network individually processes each sub-portion of the portion of signal data corresponding to a different timestep.

Example 13. The computer-implemented method of any of the preceding examples, further including: normalizing results data generated by the sigmoid activation function for each timestep to sum to one.

Example 14. The computer-implemented method of any of the preceding examples, further including: generating modified signal data comprising performing an element-wise multiplication of the one or more attention masks with the feature map.

Example 15. The computer-implemented method of any of the preceding examples, further including: pre-training the machine learning model using the contrastive learning based on: (i) a set of positive queries based on a first set of signal data corresponding to a shared identifier, or (ii) a set of negative queries associated with a first identifier based on a second set of signal data corresponding to a second identifier.

Example 16. The computer-implemented method of any of the preceding examples, where the second embedding corresponds to a first identifier, and wherein the contrastive learning using the second embedding and the first embedding includes: applying a loss function that (i) decreases as the second embedding is closer to the first embedding in a circumstance where the first embedding is associated with a shared identifier matching the first identifier, and (ii) increases as the second embedding is closer to the first embedding in a circumstance where the first embedding is associated with a second identifier that differs from the first identifier.

Example 17. The computer-implemented method of any of the preceding examples, where initiating a process based on the second embedding includes: determining a nearest embedding corresponding to the first data type in the embedding space for the second embedding by applying the second embedding to a nearest neighbor algorithm associated with identifying one or more other embedding of the first data type.

Example 18. The computer-implemented method of any of the preceding examples, where initiating a process based on the second embedding includes: determining a nearest embedding corresponding to the second data type in the embedding space for the second embedding by applying the second embedding to a nearest neighbor algorithm associated with identifying one or more other embedding of the second data type.

Example 19. A computing apparatus including memory and one or more processors communicatively coupled to the memory, the one or more processors configured to perform the computer-implemented method of any one of the preceding examples.

Example 20. One or more non-transitory computer-readable storage media including instructions that, when executed by one or more processors, cause the one or more processors to perform the computer-implemented method of any one of the preceding examples.

1. A computer-implemented method for improving an embedding space that includes a first embedding of first data having a first data type, the method comprising:
generating, by one or more processors and via a machine learning model, a second embedding having a same number of dimensions as the first embedding,
wherein the portion of first data comprises a first data type and the portion of signal data comprises a second data type,
wherein the machine learning model is trained at least in part using contrastive learning of the first data type and the second data type,
wherein the second model identifies one or more attention masks for one or more dimensions of the second embedding and generates the second embedding based on the one or more attention masks;
updating, by the one or more processors, the embedding space to include the second embedding; and
initiating, by the one or more processors, a process based on the second embedding.

2. The computer-implemented method of claim 1, further comprising:
training, by the one or more processors, the second model to generate the second embedding of the signal data in the embedding space; and
generating, by the one or more processors, the one or more attention masks for the one or more dimensions of the second embedding during training of the second model.

3. The computer-implemented method of claim 1, wherein the portion of first data comprises international classification of disease code data associated with one or more identifiers.

4. The computer-implemented method of claim 1, further comprising:
training, by the one or more processors, another machine learning model to generate the first embedding of the portion of first data in the embedding space.

5. The computer-implemented method of claim 1, wherein the portion of first data comprises a data record embodying a combination of data portions associated with a shared identifier.

6. The computer-implemented method of claim 1, wherein the portion of signal data comprises a combined signal comprising a plurality of channels that each correspond to a different data type of a plurality of different data types.

7. The computer-implemented method of claim 1, wherein generating the second embedding comprises:
inputting, by the one or more processors, the portion of signal data in parallel to each of a convolutional neural network and a convolutional attention network,
wherein the convolutional attention network generates the one or more attention masks for the one or more dimensions of the second embedding, and
wherein the second embedding is based on a combination of the one or more attention masks and a feature map generated by the convolutional neural network.

8. The computer-implemented method of claim 7, wherein the convolutional neural network comprises any number of convolutional layers, each convolutional layer comprising the same input signal length and output signal length.

9. The computer-implemented method of claim 7, wherein the convolutional attention network comprises any number of convolutional layers that generate output processed via a sigmoid activation function, and
wherein the convolutional attention network individually processes each sub-portion of the portion of signal data corresponding to a different timestep.

10. The computer-implemented method of claim 9, further comprising:
normalizing, by the one or more processors, results data generated by the sigmoid activation function for each timestep to sum to one.

11. The computer-implemented method of claim 7, further comprising:
generating, by the one or more processors, modified signal data comprising performing an element-wise multiplication of the one or more attention masks with the feature map.

12. The computer-implemented method of claim 1, further comprising:
pre-training, by the one or more processors, the machine learning model using the contrastive learning based on:
(i) a set of positive queries based on a first set of signal data corresponding to a shared identifier, or
(ii) a set of negative queries associated with a first identifier based on a second set of signal data corresponding to a second identifier.

13. The computer-implemented method of claim 1, wherein the second embedding corresponds to a first identifier, and wherein the contrastive learning using the second embedding and the first embedding comprises:
applying, by the one or more processors, a loss function that (i) decreases as the second embedding is closer to the first embedding in a circumstance where the first embedding is associated with a shared identifier matching the first identifier, and (ii) increases as the second embedding is closer to the first embedding in a circumstance where the first embedding is associated with a second identifier that differs from the first identifier.

14. The computer-implemented method of claim 1, wherein initiating the process based on the second embedding comprises:
determining, by the one or more processors, a nearest embedding corresponding to the first data type in the embedding space for the second embedding by at least applying the second embedding to a nearest neighbor algorithm associated with identifying at least one other embedding of the first data type.

15. The computer-implemented method of claim 1, wherein initiating the process based on the second embedding comprises:
determining, by the one or more processors, a nearest embedding corresponding to the second data type in the embedding space for the second embedding by applying the second embedding to a nearest neighbor algorithm associated with identifying one or more other embedding of the second data type.

16. A system for improving an embedding space that includes a first embedding of first data having a first data type, the system comprising memory and one or more processors communicatively coupled to the memory, the one or more processors configured to:
generate, via a machine learning model, a second embedding having a same number of dimensions as the first embedding,
wherein the portion of first data comprises a first data type and the portion of signal data comprises a second data type,
wherein the machine learning model is trained at least in part using contrastive learning of the first data type and the second data type,
wherein the second model identifies one or more attention masks for one or more dimensions of the second embedding and generates the second embedding based on the one or more attention masks;
updating the embedding space to include the second embedding; and
initiate a process based on the second embedding.

17. The system of claim 16, wherein to generate the second embedding, the one or more processors are configured to:
input the portion of signal data in parallel to each of a convolutional neural network and a convolutional attention network,
wherein the convolutional attention network generates the one or more attention masks for the one or more dimensions of the second embedding, and
wherein the second embedding is based on a combination of the one or more attention masks and a feature map generated by the convolutional neural network.

18. The system of claim 16, wherein to initiate a process based on the second embedding, the one or more processors are configured to:
determine a nearest embedding corresponding to the first data type in the embedding space for the second embedding by at least applying the second embedding to a nearest neighbor algorithm associated with identifying at least one other embedding of the first data type.

19. The system of claim 16, wherein to initiate a process based on the second embedding, the one or more processors are configured to:
determine a nearest embedding corresponding to the second data type in the embedding space for the second embedding by at least applying the second embedding to a nearest neighbor algorithm associated with identifying at least one other embedding of the second data type.

20. One or more non-transitory computer-readable storage media for improving an embedding space that includes a first embedding of first data having a first data type, the one or more non-transitory computer-readable storage media including instructions that, when executed by one or more processors, cause the one or more processors to:
generate, via a machine learning model, a second embedding having a same number of dimensions as the first embedding,
wherein the portion of first data comprises a first data type and the portion of signal data comprises a second data type,
wherein the machine learning model is trained at least in part using contrastive learning of the first data type and the second data type,
wherein the second model identifies one or more attention masks for one or more dimensions of the second embedding and generates the second embedding based on the one or more attention masks;
update the embedding space to include the second embedding; and
initiate a process based on the second embedding.
